(19) United States
(12) Patent Application Publication
(10) Pub. No.: US 2013/0212526 A1
(43) Pub. Date: Aug. 15, 2013

(54) METHOD OF PROVIDING INFORMATION REGARDING APPLICATION, DEVICE FOR PERFORMING THE METHOD, AND COMPUTER READABLE RECORDING MEDIUM HAVING RECORDED THEREON A PROGRAM FOR EXECUTING THE METHOD

(71) Applicants: Min-jung PARK, Suwon-si (KR); Hyo-ri Park, Seoul (KR); Bum-joo Lee, Yongin-si (KR); Say Jang, Yongin-si (KR); Ji-su Jung, Goesan-gun (KR); Seung-hwan Hong, Suwon-si (KR)

(72) Inventors: Min-jung PARK, Suwon-si (KR); Hyo-ri Park, Seoul (KR); Bum-joo Lee, Yongin-si (KR); Say Jang, Yongin-si (KR); Ji-su Jung, Goesan-gun (KR); Seung-hwan Hong, Suwon-si (KR)

(73) Assignee: Samsung Electronics Co., Ltd., Suwon-si (KR)

(21) Appl. No.: 13/617,639

(22) Filed: Sep. 14, 2012

(30) Foreign Application Priority Data
Feb. 13, 2012 (KR) 10-2012-0014403

(51) Int. Cl. G06F 3/048

(52) U.S. Cl. 715/808; 715/810

(57) ABSTRACT

A method and device for providing information regarding applications installed on a device is provided. The method includes obtaining information based on a current state of each application installed on the device; and displaying the obtained information based on the current state of each application and information identifying each application.

### PRIORITY

This application claims priority under 35 U.S.C. §119(a) to Korean Patent Application No. 10-2012-0014403, filed on Feb. 13, 2012, in the Korean Intellectual Property Office, the entire content of which is incorporated herein by reference.

### BACKGROUND OF THE INVENTION

1. Field of the Invention

The present invention relates generally to providing information regarding an application installed on a device, and more particularly, to a method of providing information based on the state of an application installed on a device, a device for performing the method, and a computer readable recording medium having recorded thereon a program for executing the method.

2. Description of the Related Art

The number of applications that may be used in devices, such as smartphones or tablet Personal Computers (PCs), is rapidly increasing. However, information regarding applications displayed on a home screen or a menu screen of a device, such as a smartphone or a tablet PC, may be present in the form of icons for identifying the applications, or title information of the applications. Thus, a user can know what applications are installed on the device, based on information regarding the applications displayed on the home screen or the menu screen of the device. However, in a conventional home screen, the user is not intuitively informed of current states of the applications installed on the device and the state of the device due to execution of the applications.

### SUMMARY OF THE INVENTION

An aspect of the present invention is to address at least the problems and/or disadvantages and to provide at least the advantages described below. The present invention provides a method of providing information regarding an application, whereby a user may know intuitively a current state of the application installed on a device, a device for performing the method, and a computer readable recording medium having recorded thereon a program for executing the method.

The present invention also provides a method of providing information regarding an application, whereby a user may know intuitively a state of a device due to execution of the application installed on the device, a device for performing the method, and a computer readable recording medium having recorded thereon a program for executing the method.

The present invention also provides a method of providing information regarding an application, which is changed according to an input signal corresponding to user's gesture, a device for performing the method, and a computer readable recording medium having recorded thereon a program for executing the method.

According to an aspect of the present invention, a method of providing information regarding applications installed on a device is provided. The method includes obtaining information based on a current state of each application installed on the device; and displaying the obtained information based on the current state of each application and information identifying each application.

According to another aspect of the present invention, a device is provided. The device includes a storage unit for storing at least one program and at least one application; a user interface unit for interacting with a user; and at least one processor for executing the at least one program, wherein the at least one program includes a command language including executable commands for obtaining information based on a current state of each application stored in the storage unit; and a command language including executable commands for displaying the obtained information based on the current state of each application and information identifying each application.

According to another aspect of the present invention, a computer readable recording medium having recorded thereon at least program including command languages for executing a method of providing information regarding applications installed on a device is provided. The method includes obtaining information based on a current state of each application installed on the device; and displaying the obtained information based on the current state of each application and information identifying each application.

### BRIEF DESCRIPTION OF THE DRAWINGS

The above and other aspects, features, and advantages of the present invention will become more apparent by describing in detail embodiments thereof with reference to the attached drawings in which:

FIG. 1 is a block diagram illustrating a structure of a device according to an embodiment of the present invention;

FIG. 2 is a block diagram illustrating an operation of collecting information in order to provide information regarding an application by using the device of FIG. 1, according to an embodiment of the present invention;

FIG. 3 is diagram illustrating an example of a management information table of applications in order to provide information regarding the applications, according to an embodiment of the present invention;

FIG. 4 is a flowchart illustrating operations of a method of providing information regarding an application, according to an embodiment of the present invention;

FIGS. 5 through 11 are diagrams illustrating examples of screens according to embodiments of present invention;

FIG. 12 is a flowchart illustrating operations of a method of providing information regarding an application, according to another embodiment of the present invention;

FIG. 13 is a flowchart illustrating operations of a method of providing information regarding an application, according to another embodiment of the present invention;

FIGS. 14 through 17 are diagrams illustrating examples of processors for changing screens according to input signals based on user's gestures in FIG. 13; and

FIG. 18 is diagram illustrating a method of providing information regarding an application performed by executing a launcher program installed in a processor, according to an embodiment of the present invention.

### DETAILED DESCRIPTION OF EMBODIMENTS OF THE PRESENT INVENTION

Embodiments of the present invention are described as follows with reference to the accompanying drawings, in which exemplary embodiments of the invention are shown. Those components that are the same or are in correspondence are rendered the same reference numeral regardless of the figure number, and redundant explanations are omitted for clarity and conciseness.

While terms such as “first,” “second,” etc., may be used to describe various components, such components must not be limited to the above terms. The above terms are merely used to distinguish components from each other.

The terms used in the following description are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

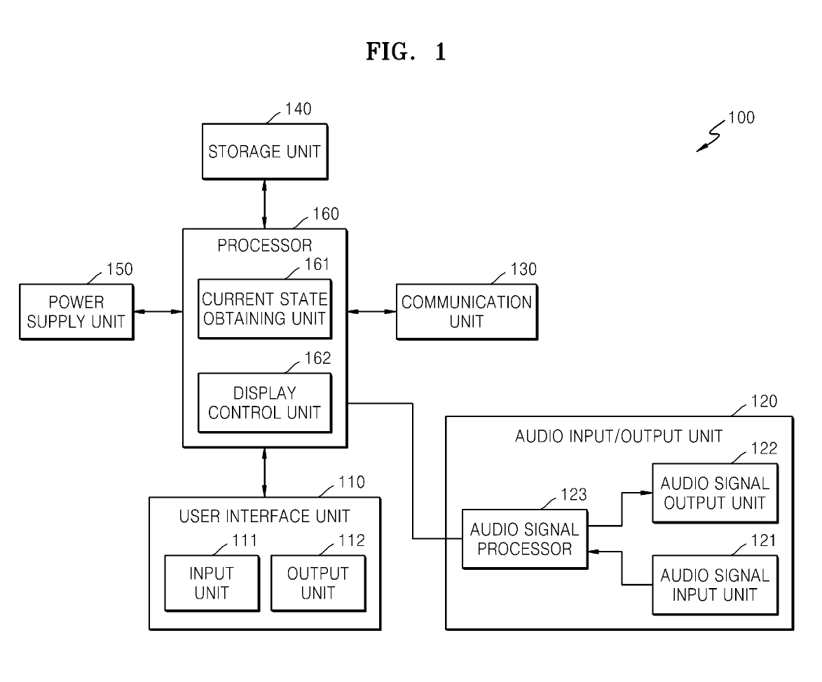

FIG. 1 is a block diagram illustrating a structure of a device according to an embodiment of the present invention.

Referring to FIG. 1, a device 100 may be device such as a smartphone, a smart TV, a Personal Computer (PC), a desktop PC, a notebook computer, a tabletop computer, a smart board, a tablet PC, a digital photo frame, a mobile device, a hand-held device or hand-held computer, a media player, a Personal Digital Assistant (PDA), etc. However, aspects of the present invention are not limited thereto, and other such devices may be used in accordance with embodiments of the present invention.

Referring to FIG. 1, the device 100 includes a user interface unit 110, an audio input/output unit 120, a communication unit 130, a storage unit 140, a power supply unit 150, and a processor 160.

The user interface unit 110 provides an interface between a user and the device 100. The user interface unit 110 includes an input unit 111 for inputting an input signal and an output unit 112 for outputting an output signal. The input unit 111 and the output unit 112 may include independent elements. The user inputs information, a command or an instruction, or data by using the input unit 111. A signal transmitted to or input to the processor 160 from the input unit 111 may be referred to as any of input information, an input command (or instruction), or an input data herein.

The input unit 111 may be configured based on a touch interface using a touch panel or a touch screen. When the input unit 111 is configured based on the touch interface, the input unit 111 and the output unit 112 are configured in a combined structure. When the input unit 111 and the output unit 112 have the combined structure based on the touch interface, the input unit 111 transmits, to the processor 160, a signal generated by sensing at least one of a touch operation and a touch strength (i.e., a value corresponding to an amount of pressure applied to the touch screen) to a screen displayed on the output unit 112 from an external input device (not shown), such as a user's finger or a stylus pen as an input signal.

The touch operations using the external input device include repeatedly touching the touch screen. In order to transmit, to the processor 160, the signal generated by sensing at least one of a touch operation and a touch strength by using the external input device, the input unit 111 may include a touch sensor (not shown). In addition to, or as an alternative to the above-described touch interface, the input unit 111 may include at least one among a physical button, a switch, and a stick, for example. Although a user's finger is provided as an example of an external input device, other instruments, such as other body parts of the user, for example, may be used as an external input device in accordance with embodiments of the present invention.

According to an embodiment of the present invention, the input signal input by the input unit 111 includes at least one of an execution request signal corresponding to an application that performs a method according to an embodiment of the present invention and an information change request signal corresponding to an application displayed on the output unit 112. The information change request signal of the application may include an execution termination request signal of the application, a request signal for collecting an executing application on an additional window, and a deletion request signal of the executing application.

The output unit 112 may include a Liquid Crystal Display (LCD), a Thin Film Transistor-Liquid Crystal Display (TFT-LCD), an Organic Light-Emitting Diode (OLED), a flexible display, a three-dimensional (3D) display, and an Active-Matrix Organic Light-Emitting Diode (AMOLED). However, embodiments of the present invention are not limited to these examples, and the output unit 112 may include other such displays in accordance with embodiments of the present invention. The output unit 112 may be referred to as a display function unit or a display herein.

The audio input/output unit 120 provides an audio interface between the user and the device 100. The audio input/output unit 120 includes an audio signal input unit 121, such as a microphone, for inputting an audio signal, an audio signal output unit 122, such as a speaker, for outputting the audio signal, and an audio signal processor 123.

The audio signal input unit 121 converts the input audio signal into an electrical signal and transmits the electrical signal to the audio signal processor 123. The audio signal processor 123 converts the electrical signal transmitted from the audio signal input unit 121 into audio data and transmits the audio data to the processor 160. The processor 160 may store the audio data received from the audio signal processor 123 in the storage unit 140 or may output the audio data to an external device via the communication unit 130. The storage unit 140 may store the audio data in a form of a file.

The processor 160 transmits the audio data read from the storage unit 140 or the audio data received via the communication unit 130 to the audio signal processor 123. The audio signal processor 123 converts the audio data transmitted from the processor 160 into an electrical signal and transmits the electrical signal to the audio signal output unit 122. The audio signal output unit 122 converts the received electrical signal into a signal that may be heard by the user and outputs the converted signal. The audio signal input unit 121 and the audio signal output unit 122 may be configured as a single body, such as a headset.

The communication unit 130 transmits and receives messages and data to and from external devices (not shown) via wired or wireless Internet, intranet, a cellular phone network, or a wireless network, such as a wireless Local Area Network (LAN), a Wireless Fidelity (Wi-Fi) network, a third-generation (3G) network, a fourth-generation (4G), a Bluetooth network, a Radio Frequency IDentification (RFID) connection, and a Zigbee network. The communication unit 130 may also transmit or receive a message or data to or from the external device by using a plug and play interface, such as a Universal Serial Bus (USB) port (not shown) for a wired connection. The external device includes an application providing server or a market server for providing various applications. The application received from the external device via the device 100 in order to implement an embodiment of the present invention includes a launcher application or a home application, such as a Launcher Pro or GO Launcher, which configures a home screen or a menu screen of the device 100.

The storage unit 140 includes memory such as a high-speed Random Access Memory (RAM), a magnetic disk storage device, nonvolatile memory, such as flash memory, or another non-volatile semiconductor memory. The storage unit 140 stores programs and resources required to perform various functions, such as, a communication function and a display function, of the device 100 including an Operating System (OS) of the device 100, and one or more programs and resources for performing a method of providing information regarding an application according to an embodiment of the present invention.

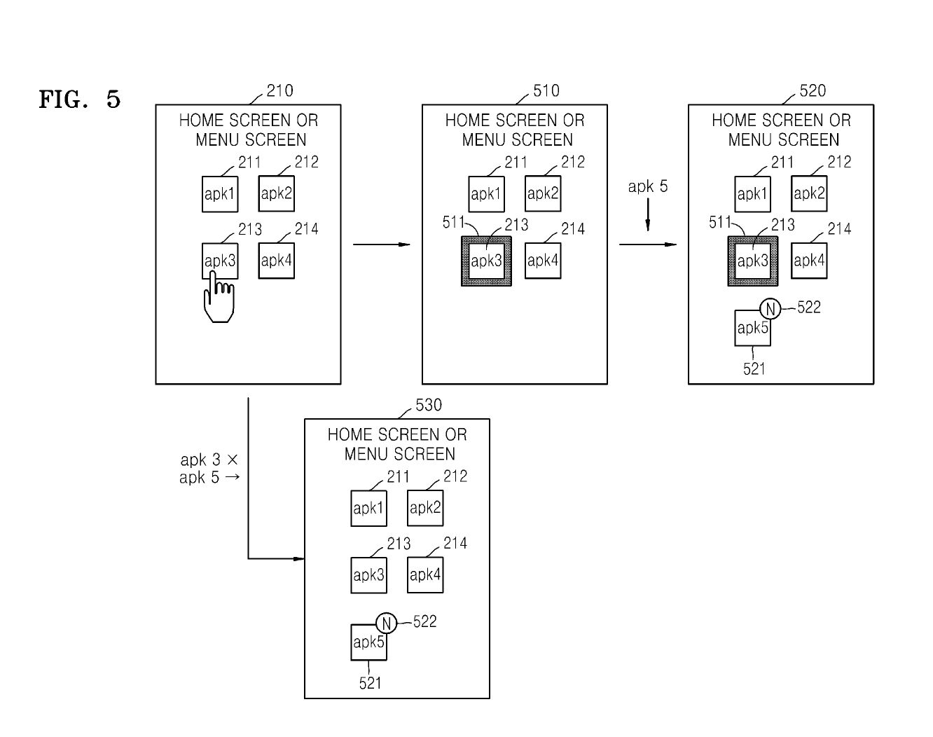

The resources according to embodiments of the present invention include information required to execute one or more programs for performing the method of providing information regarding an application according to embodiments of the present invention. The required information may include information required to indicate information based on the current state of each application according to at least one of color data, graph data, and mark data. This required in formation is described in detail with reference to FIGS. 5 through 11. In addition, the storage unit 140 may store the application installed on the device 100, as well as store resources used by the application.

The storage unit 140 may independently include a storage unit for storing at least one program required to perform various functions of the device 100 including the OS of the device 100 and a storage unit for storing one or more programs and resources for performing the method of providing information regarding an application according to an embodiment of the present invention and for storing the application installed on the device 100. The storage unit 140 may be referred to as memory herein.

The power supply unit 150 supplies power to various elements of the device 100. The power supply unit 150 includes at least one power supply, such as a battery and/or an Alternating Current (AC) power supply.

The processor 160 controls all functions of the device 100 and may include one or more processors. Although, in FIG. 1, the processor 160 is shown in a form of single chip, the processor 160 may operate as being divided into a plurality of processors according to the function of the device 100.

The processor 160 may be any of a controller, a microprocessor, a Digital Signal Processor (DSP), etc. The processor 160 operates based on an application for performing the method of providing information regarding an application according to an embodiment of the present invention. The application for performing the method of providing information regarding an application according to embodiments of the present invention includes a function of displaying information based on the current state of the application when identification information regarding the application is displayed on a home screen or a menu screen displayed on the output unit 112. Thus, such as application may be referred to as a launcher application or a home application.

The processor 160 may read an application program for executing the method of providing information regarding an application according to an embodiment of the present embodiment from the storage unit 140 or may download the application program from an external device, such as an application providing server (not shown) or a market server (not shown) connected via the communication unit 130.

As shown in FIG. 1, the processor 160 includes a current state information obtaining unit 161 and a display control unit 162. The processor 160 may further include an interface function unit (not shown) positioned between the processor 160 and various function modules in the device 100. The current state information obtaining unit 161, obtains information based on the current state included in the application program for executing the method of providing information regarding an application according to an embodiment of the present invention. The display control unit 162 controls display of both the information based on the current state included in the application program for executing the method of providing information corresponding to an application according to an embodiment of the present invention and identification information corresponding to each application.

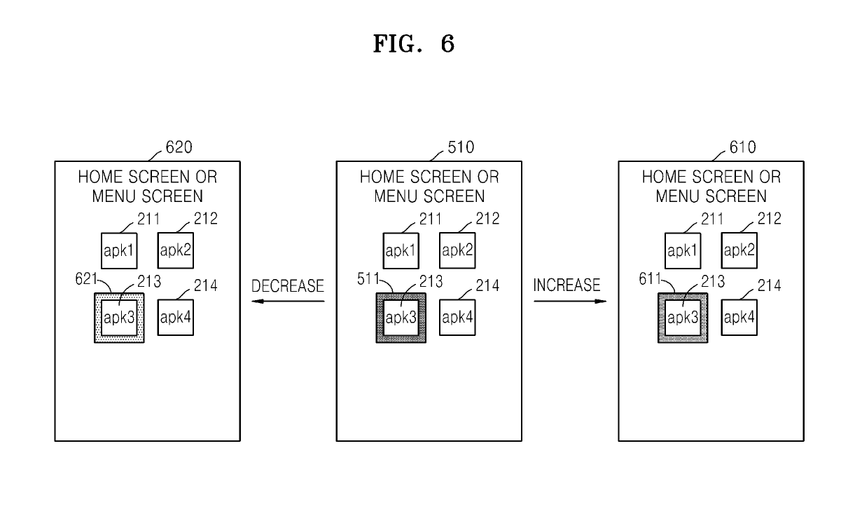

The current state information obtaining unit 161 obtains information based on the current state of each application stored in the storage unit 140. The information based on the current state of each application includes at least one of information indicating a state indicating that an application is being executed and information indicating that the application is a newly-installed application. The state information indicating that an application is being executed may be set according to a used amount of resources of the device 100 due to execution of the application. The used amount of resources of the device 100 may include at least one of an amount of used storage space and an amount of battery usage. State information indicating that an application is being executed, which is set according the used amount of the resource of the device 100, is described in detail herein below with reference to FIGS. 6 through 11. The amount of used storage space may also be referred to as a used amount of memory herein.

According to an embodiment of the present invention, the current state information obtaining unit 161 obtains the information based on the current state of each application from management information corresponding to each application stored in the storage unit 140. To this end, if identification information corresponding to a start point of an application is touched or clicked on the home screen or the menu screen, the application stores, in the storage unit 140. the information indicating the state where the application is being executed. According to an embodiment of the present invention, the identification information corresponding to the start point of the application includes at least one of an icon of the application, title information, and thumbnail information regarding the application.

When a resource of the device 100 is a storage space of the storage unit 140, each application monitors the amount of the storage space used by the storage unit 140 while the application is being executed, in real-time, and stores a monitoring result in the storage unit 140. When the device 100 is powered by a battery, each application may monitor the battery used amount while the application is being executed, in real-time, and store a monitoring result in the storage unit 140. Monitoring the amounts of used resources of the device 100 may include both monitoring the amount of used storage space and the amount of battery usage. The battery usage amount may correspond to a battery used time. Such a battery usage amount is described in more detail herein below with reference to FIGS. 6 through 11. According to an embodiment of the present invention, the information based on the current state of an application, which is collected by each application and is stored in the storage unit 140, is managed as management information regarding each application and is provided to the current state information obtaining unit 161 according to a need of the current state information obtaining unit 161.

The above-described information based on the current state of the application may be collected by the current state information obtaining unit 161 according to an embodiment the present invention. That is, the current state information obtaining unit 161 may monitor the current state of each application in real-time, obtain the above-described information based on the current state of each application, and store the obtained information in the storage unit 140. A method of obtaining information by monitoring may be performed in the same manner as the above-described method of collecting information corresponding to each application based on monitoring by each application.

The current state information obtaining unit 161 may be included in a task manager (not shown) of the device 100, which, in turn, would be included within the processor 160. For example, the task manager may be operated by an application in order to perform the method of providing information regarding an application according to an embodiment of the present invention, by collecting and managing information generated according to a task performed by the device 100. According to another example, the task manager may collect and manage information generated according to all tasks performed by the device 100. Tasks managed by the task manager may include execution of the application, checking the amount of used storage space, and checking the battery usage amount.

The display control unit 162 controls display of the information based on the current state of each application obtained by the current state information obtaining unit 161 and the identification information corresponding to each application when the home screen or the menu screen is displayed on the display unit 112. In this case, the information based on the current state of each application and the identification information corresponding to each application have a combined structure. When the information based on the current state of each application is based on mark information, the information based on the current state of each application is displayed as overlapping the identification information corresponding to each application. The mark information is information placed over an icon with at least one of a text and an image to indicate the current state of each application. The identification information corresponding to each application is a start point for executing the application when the application is clicked or touched by a user, as described above.

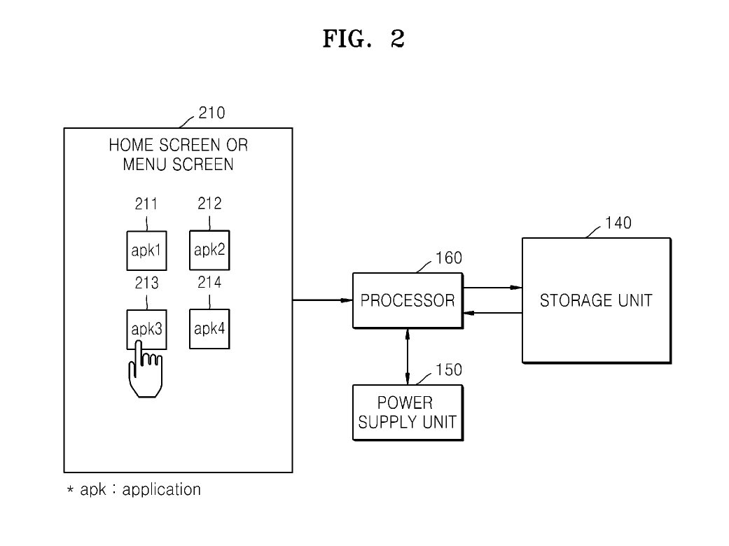

FIG. 2 is a block diagram illustrating an operation of collecting information in order to provide information regarding an application by using the device of FIG. 1, according to an embodiment of the present invention.

Referring to FIG. 2, when a home screen or a menu screen, such as a screen 210, is displayed on the output unit 112, if the user clicks or touches identification information 213 corresponding to an application 3 (abbreviated as “apk3”), the processor 160 stores, in the storage unit 140, information indicating a state in which apk3 is being executed, while executing apk3. Thus, management information regarding apk3 stored in the storage unit 140 is updated to include the information indicating the state in which apk3 is being executed.

The processor 160 monitors, in real-time, a storage space of apk3 among available storage spaces of the storage unit 140 while apk3 is being executed, and updates management information regarding apk3 so that information regarding the monitoring result is included in the management information regarding apk3. In addition, the processor 160 monitors a battery usage amount of the power supply unit 150 while apk3 is being executed and updates the management information regarding apk3 so that information regarding the monitoring result is included in the management information corresponding to apk3. Reference numeral 211 of an application 1 (abbreviated as “apk1”) illustrated in FIG. 2 represents identification information regarding apk1, and reference numeral 212 of an application 2 (abbreviated as “apk2”) of FIG. 2 represents identification information corresponding to apk2, and reference numeral 214 of an application 4 apk 4 of FIG. 2 represents identification information corresponding to apk4.

The above-described management information corresponding to each application may be managed according to each application or as one integrated management information.

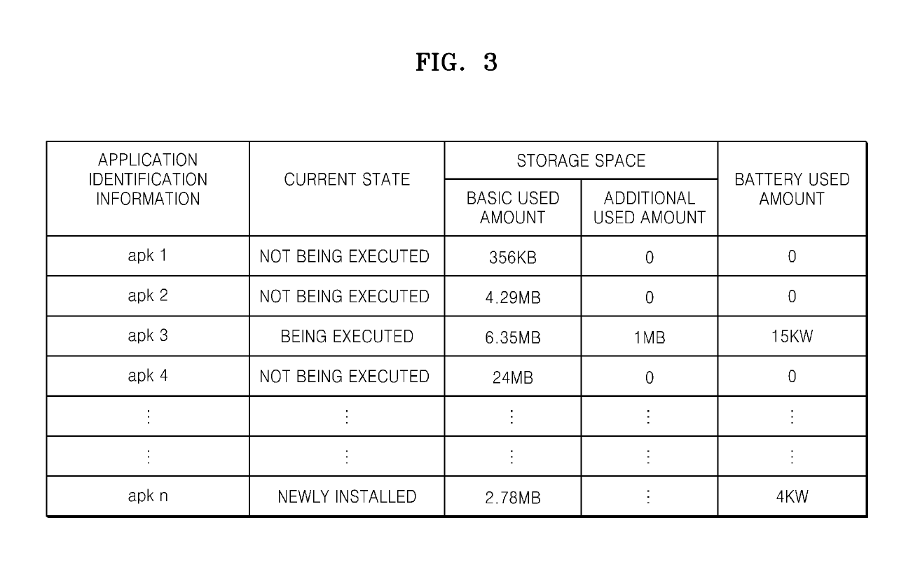

FIG. 3 is an example of a management information table of each of application in order to provide information regarding the applications, according to an embodiment of the present invention. FIG. 3 illustrates management information when apk3 is being executed, as illustrated in FIG. 2, and in case that an application n (abbreviated as “apkn”) is newly installed.

Referring to FIG. 3, applications other than the current application 3 (apk3) are not being executed, and an additional storage space among available storage spaces of the storage unit 140 due to execution of apk3 is 1 MegaByte (MB), and a battery used amount of the power supply unit 150 due to execution of apk3 is 15 kiloWatts (kW). The battery usage amount may be 4 kW as apkn is newly installed. The battery usage amount of the power supply unit 150 may be obtained based on a battery used time required for execution of the application, as described above, and the storage space used amount (or additional used amount) of the storage unit 140 may be obtained by monitoring a data write operation into the storage unit 140 when the application is executed. However, measuring the battery usage amount and the amount of storage space used caused by execution of the application is not limited thereto. Values illustrated in FIG. 3 are merely provided as examples, and other values may be used in accordance with embodiments of the present invention. When management information is collected according to each application, information based on the current state of each application may be collected and managed as illustrated in FIG. 3. Referring to apkn, information indicating that the application n is newly installed may be stored as management information or may be monitored by the current state information obtaining unit 161 of the processor 160 and thus may be stored in a management information table stored in the storage unit 140.

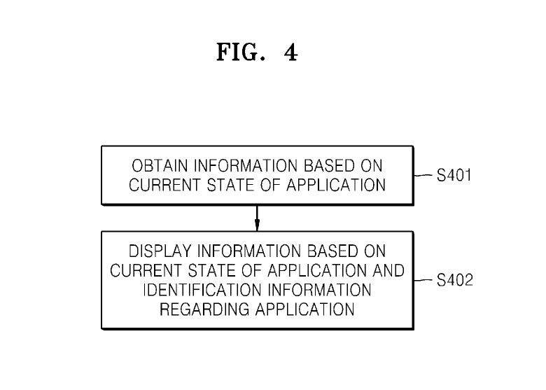

FIG. 4 is a flowchart illustrating operations of a method of providing information regarding an application, according to an embodiment of the present invention.

Referring to FIG. 4, the processor 160 obtains information based on a current state of an application for performing a method of providing information corresponding to an application in step S401. Step S401 may be performed after identification information regarding the application is touched or clicked on a home screen or a menu screen, such as the screen 210 of FIG. 2, when the application for performing the method of providing information regarding an application is set as a home application, such as a launcher program, in the device 100. However, when the application for performing the method of providing information regarding an application is installed as one application included in the home screen or the menu screen, if the identification information regarding the application for performing the method is touched or clicked on the home screen or the menu screen, the processor 160 obtains information based on the current state of the application by reading the management information illustrated in FIG. 3 stored in the storage unit 140 or by reading the management information regarding each application.

The information based on the current state of the application includes at least one of information indicating a state where the application is being executed, and information indicating a newly-installed application, as illustrated in FIG. 3. For example, as the user clicks the identification information regarding apk3, as shown on the screen 210 of FIG. 2, the current state of apk3, which indicates that apk3 is being executed, is obtained. The information indicating a newly-installed application is obtained when a new application is installed, and identification information regarding the new application is generated and installed on the home screen or the menu screen.

If the information based on the current state of the application is obtained, the processor 160 displays the information based on the current state of the application and the identification information regarding the application on the output unit 112 in step S402.

FIG. 5 is a diagram illustrating an example of screens on which information based on a current state of an application and identification information regarding the application are displayed, according to an embodiment of the present invention.

Referring to FIG. 5, when the user clicks or touches identification information regarding apk3 on the home screen or the menu screen, such as the screen 210 of FIG. 2, the screen 210 displayed on the output unit 112 by the processor 160 is changed into a screen 510.

Referring to the screen 510 of FIG. 5, identification information 213 of apk3 and information 511 indicating a state that apk3 is being executed, in the vicinity of the identification information 213, are displayed together. The information 511 indicating that apk3 is being executed may be displayed as preset color information (i.e., a preset color scheme). For example, the information 511 indicating that apk3 is being executed may be indicated by a displayed color, such as red, yellow, and blue. The preset color information may be set by the user. The color information that may be used by the user in accordance with embodiments of the present invention is not limited to the above-described three colors. Through the color information, a user will be intuitively informed, from the home screen or the menu screen based on the screen 510, that apk3 is being executed.

In addition, if, in step 401, information indicating that a new application 5 (abbreviated as “apk5”) is installed is obtained, the processor 160 displays the home screen or the menu screen on which preset mark information 522 overlaps the identification information 521 of the newly-installed apk5, as shown on a screen 520 of FIG. 5, on the output unit 112 in step S402. Thus, the user will be intuitively informed that apk5 is a newly-installed application and the apk3 is being executed. After apk5 has been installed, the processor 160 may maintain the display state of the mark information 522 for a predetermined period before apk5 is first used. The predetermined period may be set as one week, for example. The predetermined period may be set by the user. Since the mark information 522 may be set by the user, embodiments of the present invention are not limited to the above-described example.

If, in step S401, information indicating that only the new application apk5 is installed is obtained, the processor 160 changes the screen 210 of FIG. 2 into a screen 530 of FIG. 5 and displays the information on the screen 530. The user will be intuitively informed that apk5 is newly installed, based on the screen 530 of FIG. 5.

If information regarding the used amount of resources of the device 100 due to execution of the application is included in the information based on the current state obtained in step S401, the processor 160 changes the information indicating that the application is being executed according to the used amount of resources of the device 100.

For example, when a resultant value obtained by monitoring the amount of storage space used by the storage unit 140 due to execution of the application is included in the information based on the current state of the application obtained in operation S401, the processor 160 changes the information 511 indicating that the application is being executed according to whether the amount of used storage space is increased or decreased relative to the previous amount of used storage space, as illustrated in FIG. 6.

FIG. 6 is a diagram illustrating another example of screens on which information indicating a state where an application is being executed, is changed according to a used amount of a storage space of a storage unit, according to another embodiment of the present invention.

Referring to FIG. 6, when apk3 is executed and the amount storage space used by the storage unit 140 is increased relative to the previous amount of used storage space, a screen 510 is changed into a screen 610. Referring to the screen 610, information 611 based on the current state of apk3 is different from the information 511. However, when apk3 is executed and the amount of used storage space is less than the previous amount of used storage space, the screen 510 is changed into a screen 620. Referring to the screen 620, information 621 based on the current state of apk3 is different from the information 511.

The information 511, 611, and 621 may be represented as different color information. If the storage space used amount of the storage unit 140 of apk3 is decreased in a state where the information based on the current state of the application is being displayed as the color information 611, the processor 160 may display the color information 621. However, if the amount of storage space used by the storage unit 140 for apk3 is increased in a state where the information based on the current state of the application is being displayed as the color information 621, the processor 160 displays the color information 611.

An increase or a decrease in the amount of storage space used by the storage unit 140 due to execution of apk3 may be monitored in real-time, and color information regarding the information based on the current state of the application may be changed whenever the monitoring operation is performed in real-time. However, when the above-described monitoring operation is performed by a preset time, color information regarding the information based on the current state of the application may be changed according to the preset time. The preset time may be set as 1 or 5 minutes, for example, but other times may be used in accordance with embodiments of the present invention. According to an embodiment of the present invention, the preset time is set by the user, while in other embodiments of the present invention, the preset time is not set by the user.

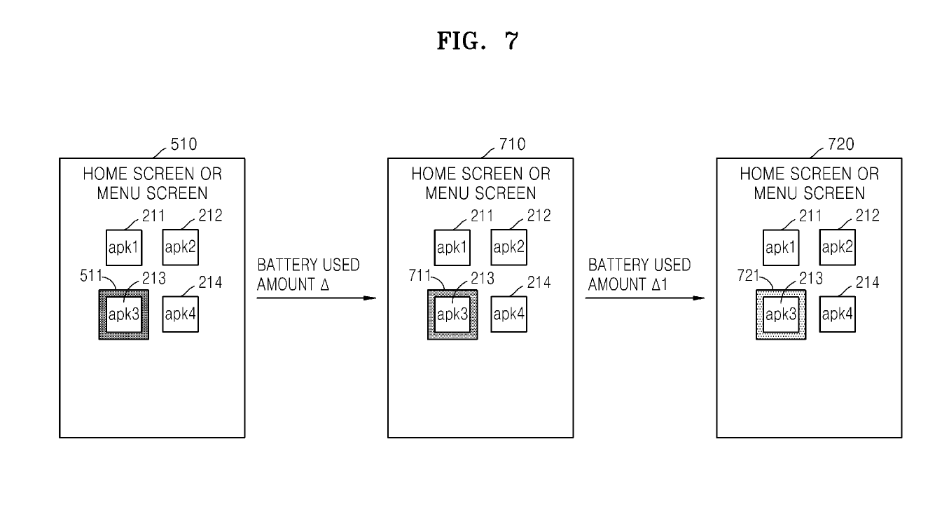

FIG. 7 is a diagram illustrating another example of screens on which information indicating a state where an application is being executed, is changed according to a battery usage amount, according to another embodiment of the present invention.

Referring to FIG. 7, a screen 510 a home screen or a menu screen indicating a state that apk3 is being executed. If the battery usage amount of the power supply unit 150 is obtained as Δ due to execution of apk, the processor 160 displays a screen 710 on the output unit 112. Referring to the screen 710, the information 511 based on the current state of apk3 is changed into 711. If the battery usage amount of the power supply unit 150 is obtained as Δ1, as a result of continuously monitoring the battery used amount, the processor 160 changes the screen 710 into a screen 720 and displays the screen 720 on the output unit 112. Referring to the screen 720, information 721 based on the current state of apk3 is changed. The battery usage amount of the power supply unit 150 may be monitored based on a predetermined usage amount, as described above, but may be monitored in real-time or by a preset time like monitoring the storage space used amount of the storage unit 140 in accordance with embodiments of the present invention. The user is intuitively informed of the battery usage amount of an executing application, based on the displayed screen, as illustrated in FIG. 7.

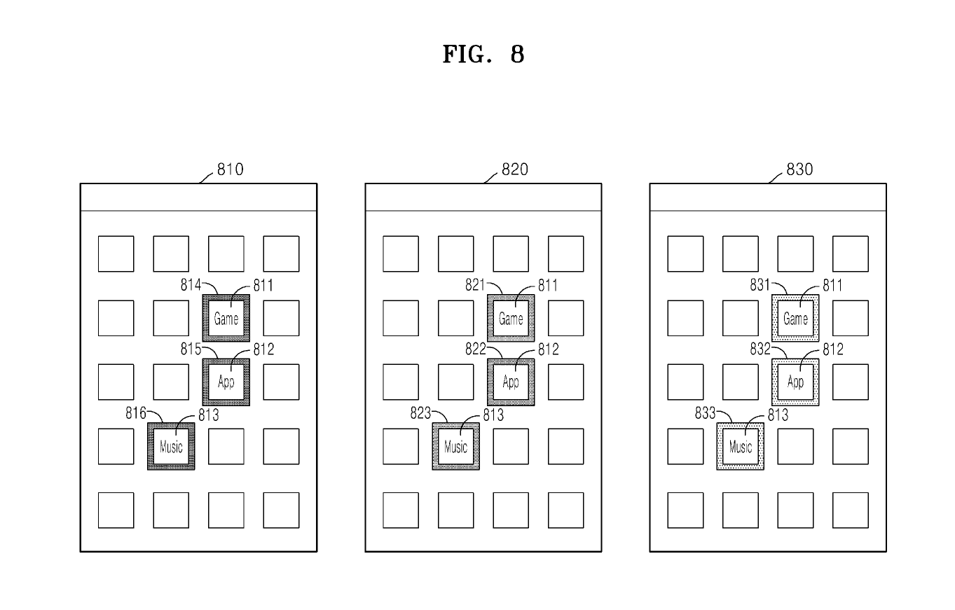

FIG. 8 is a diagram illustrating another example of screens on which, when the device 100 performs multi-tasking, information indicating a state of an executing application is changed, according to another embodiment of the present invention.

Referring to FIG. 8, as illustrated in a screen 810, when Game, App, and Music applications 811, 812, and 813 among applications installed on the device 100 are in a multi-tasked state, the processor 160 monitors the entire amount of the resources used by the device 100 due to execution of the three applications 811, 812, and 813 and displays one of screens 820 and 830 on the output unit 112 based on the monitoring result.

The processor 160 monitors the entire amount of the resources used by the device 100 due to execution of the applications 811, 812, and 813 in the multi-tasked state is performed using a method similar to the method of monitoring the used amount of the resource of the device 100 due to execution of apk3 213, as described above. However, reference values for monitoring according to the presently-described embodiment of the present invention are not identical to that of the previously-described method. For example, a determination criterion for monitoring is a usage amount, a criterion for determining the entire usage amount of the resource of the device 100 due to execution of the applications 811, 812, and 813 in the multi-tasked state and a criterion for determining the usage amount of the resource of the device 100 due to execution of apk3 213 may differ from each other. However, when a determination criterion for monitoring is time, the criterion for determining the entire amount of the resources of the device 100 used due to execution of the applications 811, 812, and 813 in the multi-tasked state and the criterion for determining the amount of the resources of the device 100 used due to execution of apk3 213 may be the same. The above-described monitoring criteria may be set by the user and may be flexibly changed according to circumstances, and aspects of the present invention are not limited thereto. Reference numerals 814, 815, and 816 on the screen 810 of FIG. 8 each represent information indicating a state where each of the Game application 811, the App application 812, and the Music application 813 is being executed, and reference numerals 821, 822, and 823, and 831, 832, and 833 each represent information indicating a state where each of the Game application 811, the App application 812, and the Music application 813 changed according to a change in the amount of resources used by the device 100 due to execution of the three applications 811, 812, and 813 is being executed.

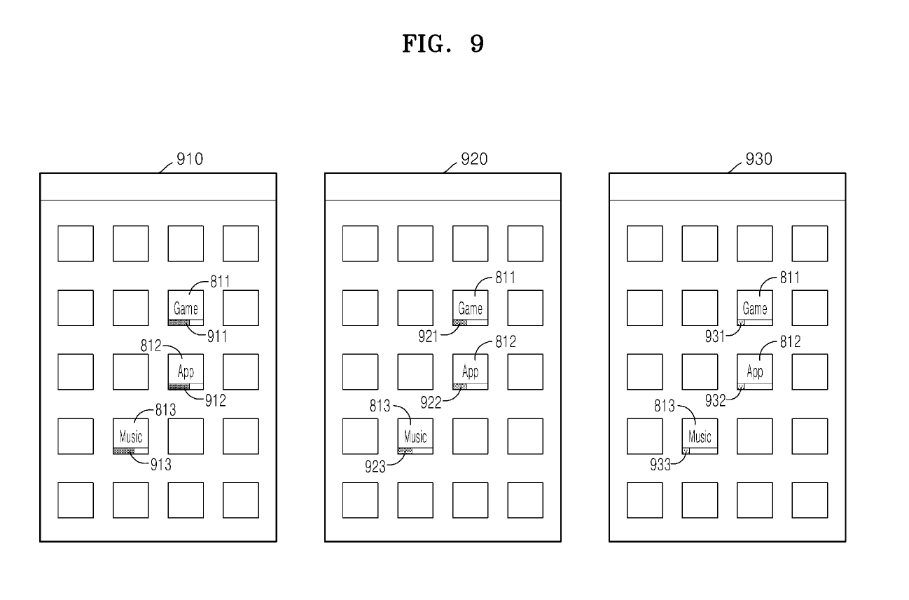

FIG. 9 is a diagram illustrating another example of screens on which, when the device 100 performs multi-tasking, information indicating a state where an application is being executed is changed, according to another embodiment of the present invention.

FIG. 9 is a diagram illustrating a change in information indicating that an application based on an amount of resources used by a device is being executed, as graph information.

Referring to FIG. 9, screens 910, 920, and 930 of FIG. 9 represent the entire amount of the resources of the device 100 used due to execution of the three applications 811, 812 and 813 and information about the executing application 811, 812, and 813. That is, screen 910 of FIG. 9 represents that the entire amount of the resources of the device 100 used due to execution of the three applications 811, 812, and 813 is more than 50% of available amounts of the resources of the device 100. Screen 920 of FIG. 9 indicates that the entire amount of the resources of the device 100 used due to execution of the three applications 811, 812, and 813 is between 30% and 49% of available amounts of the resource of the device 100. Screen 930 of FIG. 9 indicates that the entire amount of the resources of the device 100 used due to execution of the three applications 811, 812, and 813 is between 0% and 29% of available amounts of the resources of the device 100 due to execution of the three applications 811, 812, and 813. Information 911, 912, 913, 921, 922, 923, 931, 932, and 933 are bar graph information indicating the entire amount of the resources of the device 100 used due to execution of the three applications 811, 812, and 813.

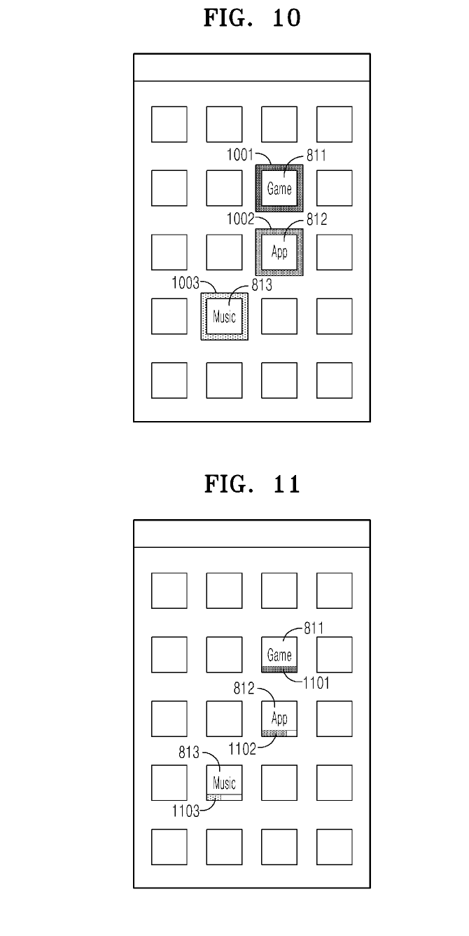

FIG. 10 is a diagram illustrating another example of a screen on which, when a device performs multi-tasking, information indicating a state in which an application is being executed according to the amount of the resources of the device used due to execution of the application, is displayed based on color information, according to another embodiment of the present invention.

Referring to FIG. 10, the Game application 811, the App application 812, and the Music application 813 are multi-tasked. However, information 1001, 1002, and 1003, which each indicate a state where the Game application 811, the App application 812, and the Music application 813 each is being executed, may be different from each other, and the user is intuitively informed of the amount of resources used by the device 100 due to execution of the three applications 811, 812, and 813.

FIG. 11 is a diagram illustrating another example of a screen on which, when the device 100 performs multi-tasking, information indicating a state where an application is being executed according to the used amount of the resource of the device 100 due to execution of the application, is displayed based on graph information, according to another embodiment of the present invention.

Referring to FIG. 11, the Game application 811, the App application 812, and the Music application 813 are multi-tasked. However, information 1101, 1102, and 1103, which each indicate that the Game application 811, the App application 812, and the Music application 813 are each being executed, respectively, may be different from each other. Based upon information 1101, 1102, and 1103, the user is informed of the amount of resources used by the device 100 due to execution of each the three applications 811, 812, and 813.

According to embodiments of the present invention, in the method of providing information corresponding to an application described with reference to FIG. 4, changing the information indicating that an application is being executed is not limited to the examples described with reference to FIGS. 6 through 11. For example, although the embodiments described with reference to FIGS. 6 through 11 refer to three colors three examples of graph information, but a different number of colors used for color information and/or a different number to types of graphs used for graph information may be utilized in accordance with embodiments of the present invention. Predetermined mark information may also be used instead of the color information and the graph information may be used. Such configurations may be set as a default when the device 100 is manufactured and/or may be set by the user.

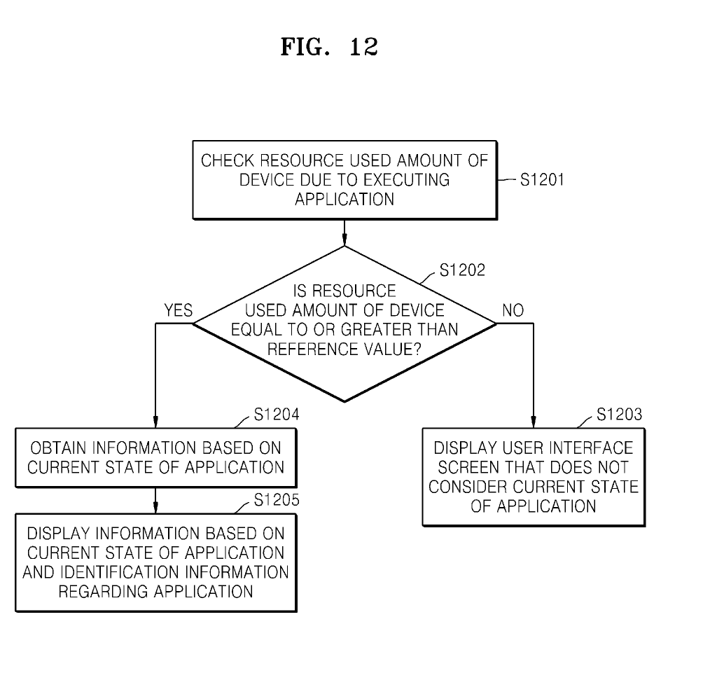

FIG. 12 is a flowchart illustrating operations of a method of providing information regarding an application, according to another embodiment of the present invention. In FIG. 12, when the used amount of the resource of the device 100 due to execution of at least one application is equal to or greater than a reference value, information regarding the application is provided.

Referring to FIG. 12, the processor 160 checks the amount of resources used by the device 100 due to an executing application, in step S1201. The amount of resources may be checked in real-time or according to a preset time, such as described herein above. In step S1202, the processor 160 determines whether the amount of used resources is greater than or equal to a reference value. If the used amount of used resources is less than the reference value, the processor 160 displays a user interface screen that does not consider the current state of the application, in step S1203. The user interface screen includes a home screen or a menu screen. The reference value may be set as a default in the application for performing the method of providing information regarding an application illustrated in FIG. 12 or may be set by the user.

However, if the amount of resource used by the device 100 is greater than or equal to the reference value, the processor 160 performs steps S1204 and S1205, which correspond to S401 and S402 described herein with reference to FIG. 4.

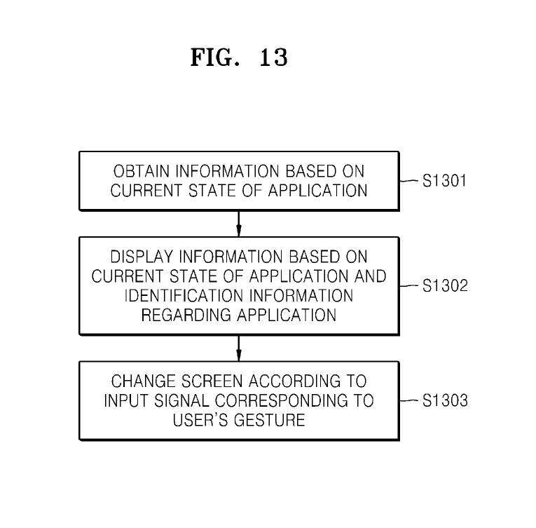

FIG. 13 is a flowchart illustrating operations of a method of providing information regarding an application, according to another embodiment of the present invention. The operations of FIG. 13 are similar to that of FIG. 4, but further include a function of changing a screen according to an input signal based on user's gesture. Steps S1301 and S1302 of FIG. 13 correspond to steps S401 and S402 of FIG. 4, and thus, a further description of these steps is omitted.

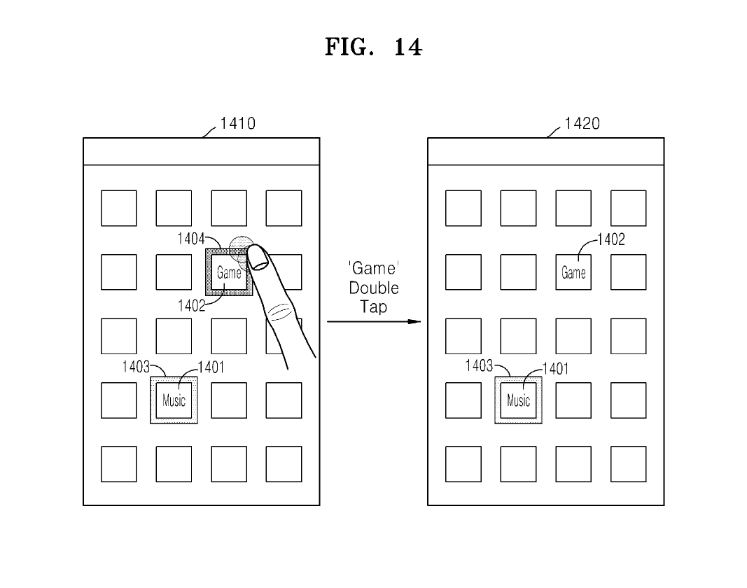

FIGS. 14 through 17 are examples of processes of changing screens according to input signals based on user's gesture according to embodiments of the present invention.

Referring to FIG. 14, when a screen displayed in step S1302 includes information 1403 and 1404 each indicating that a Music application 1401 and a Game application 1402 are in a multi-tasked state, as shown on a screen 1410 of FIG. 14, if, in step S1303, a signal based on user's gesture corresponding to double tapping the Game application 1402 is input to the processor 160, the processor 160 displays a screen 1420 indicating that execution of the Game application 1402 is terminated, on the output unit 112. Thus, the user is informed that the Game application 1402 is terminated and only the Music application 1401 is being executed.

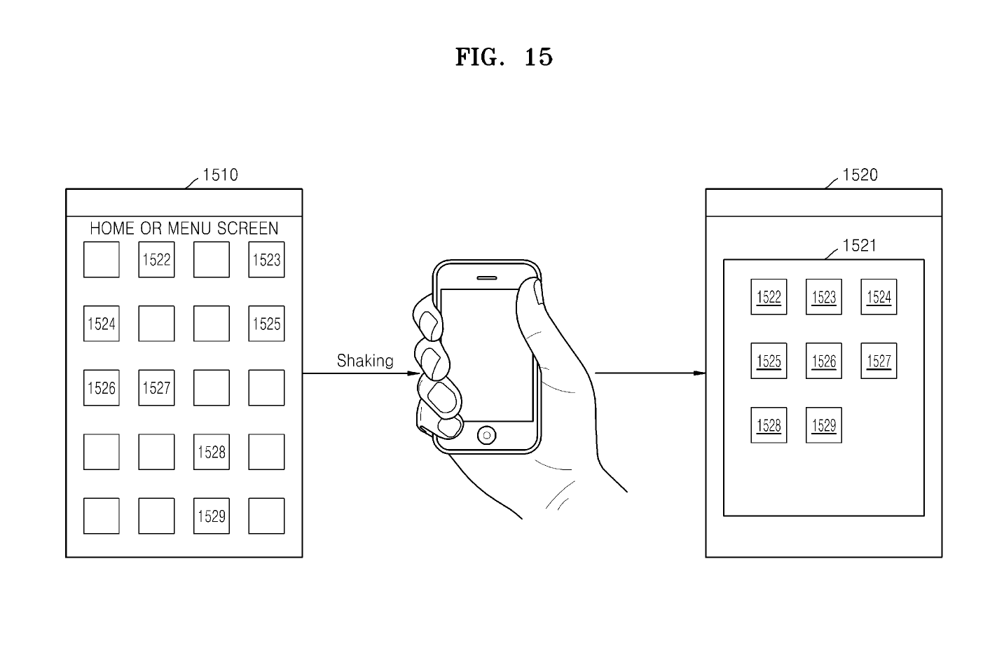

Referring to FIG. 15, when a screen displayed in step S1302 is a home screen or a menu screen 1510 including information indicating that 8 applications 1522 to 1529 shown on a screen 1520 are in a multi-tasked state, if, in step S1303, a signal based on user's gesture corresponding to shaking the device 100 is input to the processor 160, the processor 160 gathers the applications 1522 to 1529, and displays the gathered applications 1522 to 1529 in a form of a pop-up window 1521 on the screen 1520 of FIG. 5. The pop-up window 1521 may also be referred to as a multi-tasking information window, an information window of an executing application, or a predetermined region included in a display region of the output unit 112.

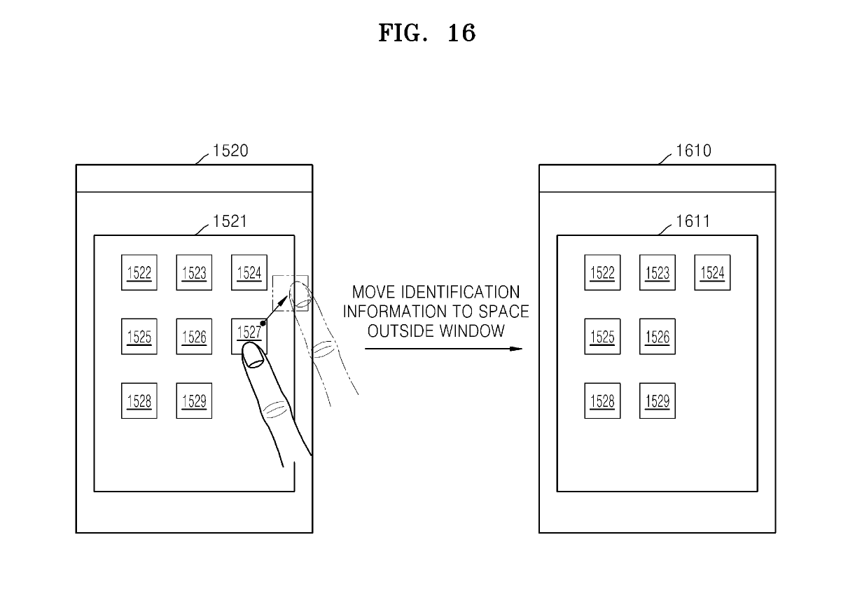

Referring to FIG. 16, while the screen 1520 is displayed on the output unit 112 in step S1303, if a signal based on a user's gesture corresponding to moving or dragging at least one application (such as application 1527 among the applications 1522 to 1529 displayed on the pop-up window 1521, in the present example) to a region other than the pop-up window 1521, as shown on a screen 1520 of FIG. 16, is input to the processor 160, the processor 160 terminates execution of the moved application 1527. Thus, the screen 1610 of FIG. 16 is displayed on the output unit 112, and the user may know intuitively that the applications 1522 to 1526, 1528, and 1529 are in a multi-tasked state. In FIG. 16, only one application 1527 on the pop-up window 1521 is moved to the region other than the pop-up window 1521. However, embodiments of the present invention are not limited thereto, and a signal based on user's gesture corresponding to moving a plurality of applications to a region other than the pop-up window 1521 may be input to the processor 160.

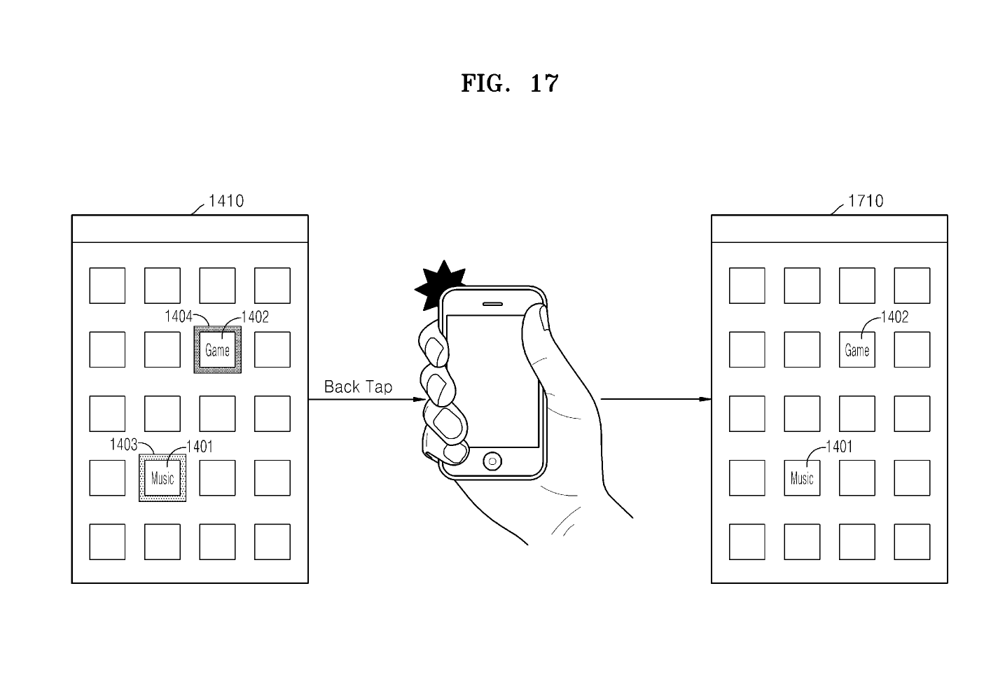

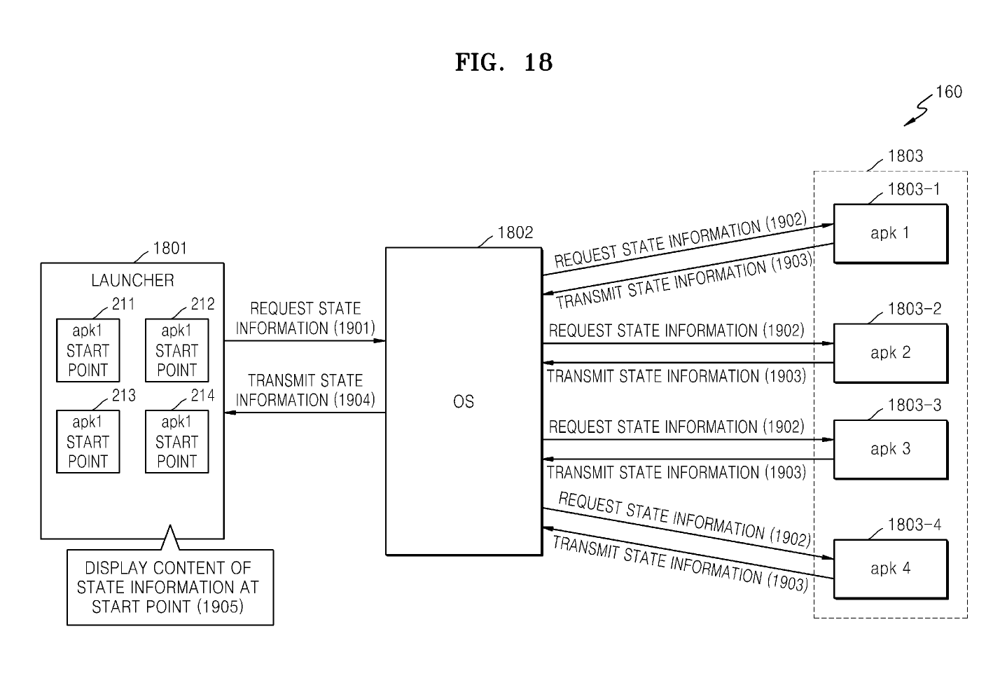

When a screen displayed in operation S1302 includes information 1403 and 1404 each indicating a state where a Music application 1401 and a Game application 1402 are in a multi-tasked state, as shown on a screen 1410 of FIG. 17, if, in operation S1303, a signal based on user's gesture corresponding to back tapping a back side of the device 100 is input to the processor 160, the processor 160 displays a screen 1710 indicating that execution of the Music application 1401 and the Game application 1402 is terminated, on the output unit 112. Thus, the user may know intuitively that all of the executing Music application 1401 and the executing Game application 1402 are terminated. Back tapping mentioned in FIG. 17 may be replaced with striking or knocking one side of the device 100.

FIG. 18 is diagram illustrating a method of providing information regarding an application performed by executing a launcher program 1801 installed in a processor 160, according to another embodiment of the present invention.

That is, if the launcher program 1801 installed in the processor 160 is executed, information based on a current state regarding each application is requested to an Operating System (OS) 1802 installed in the processor 160, in step 1901. The OS 1802 may be any of a variety of operating systems, including mobile operating systems such an ANDROID®-based OS or an iOS®-based OS. The OS 1802 sends a request for information based on a current state of each of applications apk1 1803_1 to apk4 1803_4 to each of these applications, in step 1902. Thus, the applications apk1 1803_1 to apk4 1803_4 transmit their current state-based information to the OS 1802, in step 1903. The applications apk1 1803_1 to apk4 1803_4 that transmit their current state-based information may be being executed or not. Reference numeral 1803 represents an element based on an integrated management information table when the information based on the current states of the applications apk1 1803_1 to apk4 1803_4 are integrated and managed, as illustrated in FIG. 3. The element 1803 may be implemented as an entity that provides the information based on the current states of the applications apk1 1803_1 to apk4 1803_4 to the OS 1802.

The OS 1802 transmits the information based on the current states received from the applications apk1 1803_1 to apk4 1803_4 to the launcher program 1801, in step 1904. Thus, the launcher program 1801 displays information indicating that each of the applications apk1, apk2, apk3, and apk4 is being executed at their start points 211 to 214, or information indicating that the applications apk1, apk2, apk3, and apk4 are newly-installed applications, according to the received information based on the current states of the applications apk1 1803_1 to apk4 1803_4, as illustrated in FIGS. 5 through 11 described herein above, in step 1905.

A method of providing information regarding an application according to embodiments of the present invention and programs including command languages for executing a method of performing application information provision by using a computer can be recorded as computer readable codes on a computer readable recording medium. The computer readable recording medium is any data storage device that can store data that can be thereafter read by a computer system. Examples of the computer readable recording medium include Read-Only Memory (ROM), Random-Access Memory (RAM), Compact Disc (CD)-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to certain embodiments thereof, it will be understood by those skilled in the art that various changes in form and details may be made therein without departing from the spirit and scope of the invention as defined by the appended claims. The described embodiments should be considered in descriptive sense only and not for purposes of limitation. Therefore, the scope of the invention is not defined by the detailed description of the invention but by the appended claims and their equivalents.

What is claimed is:

1. A method of providing information regarding applications installed on a device, the method comprising:
obtaining information based on a current state of each application installed on the device; and
displaying the obtained information based on the current state of each application and information identifying each application.

2. The method of claim 1, wherein the information based on the current state of each application includes at least one of information indicating a whether the application is being executed, and information indicating whether the application is newly-installed.

3. The method of claim 2, wherein the information indicating whether the application is being executed includes information set according to an amount of resources used by the device due to execution of the application.

4. The method of claim 2, wherein the information indicating whether the application is being executed includes information set according to a total amount of resources used by the device due to execution of the applications installed on the device and an amount of resources used by the application.

5. The method of claim 3, wherein the information indicating whether the application is being executed includes information based on at least one of color information, graph information, and predetermined mark information corresponding to an amount of resources used by the device.

6. The method of claim 3, wherein the resources used by the device include at least one of a storage space and a battery of the device.

7. The method of claim 2, wherein the information indicating a new-installed application includes information indicating whether an application is being executed or not after newly installing the application.

8. The method of claim 1, wherein the information is displayed according whether an amount of resources used by the device due to execution of at least one application installed on the device is at least equal to a reference value.

9. The method of claim 1, further comprising:
receiving an input signal corresponding to a user's gesture corresponding to at least one selected application on a screen on which the information based on the current state of each application and the identification information regarding the selected application are displayed;
changing information displayed regarding the at least one selected application according to the input signal.

10. The method of claim 9, wherein the user's gesture includes at least one of shaking the device, striking one side of the device, knocking one side of the device, double tapping identification information regarding at least one selected application, and moving the identification information regarding the at least one selected application and information based on the current state of the at least one selected application to a region other than a predetermined region.

11. The method of claim 9, wherein the changing the information regarding the at least one selected application included on the screen includes at least one of changing an execution state of the at least one selected application, displaying a pop-up window on which identification information regarding at least one executing application is gathered, and deleting information regarding the at least one executing application.

12. The method of claim 1, wherein the obtained information is displayed on a home screen or a menu screen on the device.

13. A computer readable recording medium having recorded thereon at least one program comprising command languages for executing a method of providing information regarding applications installed on a device, the method comprising:
obtaining information based on a current state of each application installed on the device; and
displaying the obtained information based on the current state of each application and information identifying each application.

14. A device comprising:
a storage unit for storing at least one program and at least one application;
a user interface unit for interacting with a user; and
at least one processor for executing the at least one program,
wherein thereat least one program comprises:
a command language including executable commands for obtaining information based on a current state of each application stored in the storage unit; and
a command language including executable commands for displaying the obtained information based on the current state of each application and information identifying each application.

15. The device of claim 14, wherein the information based on the current state of each application includes at least one of information indicating a whether the application is being executed, and information indicating whether the application is newly-installed.

16. The device of claim 15, wherein the information indicating whether the application is being executed includes information set according to an amount of resources used by the device due to execution of the application.

17. The device of claim 16, wherein the information indicating whether the application is being executed includes information based on at least one of color information, graph information, and predetermined mark information corresponding to an amount of resources used by the device.

18. The device of claim 14, wherein the at least one program is executed according to whether an amount of resources used by the device due to execution of at least one application stored in the storage unit is at least equal to a reference value.

19. The device of claim 16, wherein the resources of the device comprises at least one of a storage space and a battery of the device.
